(19) United States
(12) Patent Application Publication
(10) Pub. No.: US 2005/0086412 A1
(43) Pub. Date: Apr. 21, 2005

(54) System and method for communicating between modules

(76) Inventors: Cesar Douady, Orsay (FR); Philippe Boucard, Le Chesnay (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 10/884,794

(22) Filed: Jul. 2, 2004

(30) Foreign Application Priority Data
Jul. 4, 2003 (FR) FR 0308225

(51) Int. Cl. G06F 13/14

(52) U.S. Cl. 710/305

(57) ABSTRACT

System for communicating between modules, comprising an initiator element, at least one intermediate element and one slave element, the initiator element being equipped with means for formulating and sending a first request to an intermediate element, the said first request comprising the address of the initiator element, the address of the intermediate element, data, and at least one instruction having to be processed by the intermediate element, the intermediate element being equipped with means for receiving a request originating from the initiator element, for formulating a second request in response to the first request, and for sending the second request to a slave element, the said second request comprising the address of the slave element, at least one instruction having to be processed by the slave element, data, and the address of the initiator element, the slave element being equipped with means for receiving a request originating from the intermediate element, and for executing at least one instruction contained in the second request.

### BACKGROUND OF THE INVENTION

1. Field of the Invention

The present invention relates to the field of communication between modules.

2. Description of the Relevant Art

In the field of computing, conventional systems are centered around a specialized bus which interconnects several agents. Here, “agent” is understood to mean an element able to receive or to dispatch data over a bus, for example a central processing unit, a memory, an input/output device, etc.

According to a specific protocol individual to the bus, only one agent can dispatch a message over the bus simultaneously. The execution of processing requires that operands be present in the agent that will execute the processing and consequently demand the transfer of data between agents via the communication system. Here, “operand” is understood to mean an element to which an operation pertains.

For example, a system comprising an arithmetic coprocessor and a memory of SDRAM type which contains data must, in order for it to be possible for an operation to be executed, transfer the operands stored in the memory by way of the controller of the memory, then by way of the bus to the coprocessor. The results of the operation will be transferred over the same bus.

This results in the number of exchanges being limited due to the use of a bus that forms a single and bounded communication resource, the bandwidth of the communication system formed by the bus being finite.

In applications where high performance is necessary, the execution of a program requires a specific organization of the instructions so as to optimize and best sequence the various exchanges between the agents that are connected to the communication bus, so as to optimize the use of the bandwidth. The compilers may take charge of this type of problem, but in a non-optimal manner and under the proviso that a part of the resources of the system is used for the management of these exchanges. The system thus loses efficiency and the performance degrades more quickly the higher the number of agents that are present on the communication bus.

To remedy these drawbacks, it is desirable for it to be possible for several requests to be dispatched simultaneously between the various agents present and for all the agents to work in parallel and sequentially without it being necessary to have a general sequencer to arrange the general datastream in order.

### SUMMARY OF THE INVENTION

Described herein is a system and method that aims to remedy the drawbacks of such a conventional system.

Proposed is a particularly powerful system and method of communication allowing extremely fast communications between various agents by making judicious use of the capabilities of the communication system.

The system for communicating between modules includes an initiator element, at least one intermediate element and one slave element. The initiator element is equipped with means for formulating a first request, and with means for sending the first request to the intermediate element.

The first request includes the address of the initiator element, the address of the intermediate element, data, and at least one instruction having to be processed by the intermediate element. The intermediate element is equipped with means for receiving a request originating from the initiator element, with means for formulating a second request in response to the first request, and with means for sending the second request to a slave element.

The second request comprises the address of the slave element, at least one instruction having to be processed by the slave element, data, and the address of the initiator element. The slave element is equipped with means for receiving a request originating from the intermediate element, and with means for executing at least one instruction contained in the second request.

Complex operations are thus permitted that require only a small number of requests or messages. It is generally possible to dispense with messages dispatched by the intermediate element to the initiator element or else with messages dispatched by the slave element to the intermediate element.

In one embodiment, the slave element includes means for sending an acknowledgement of receipt to the initiator element in response to the second request. The acknowledgement of receipt will be sent without passing via the intermediate element. The number of messages having to pass through the communication system is thus reduced.

In one embodiment, the slave element includes means for sending data to the initiator element.

In one embodiment of the invention, the system includes a plurality of intermediate elements, an intermediate element of rank n including means for sending a request of rank n+1 to an intermediate element of rank n+1 in response to a request of rank n. The request of rank n+1 includes the address of the intermediate element of rank n+1, at least one instruction having to be processed by the intermediate element of rank n+1, and the address of the initiator element.

A request may therefore pass through a large number of intermediate elements, each performing therein the processing for which it is envisaged and sending a new request to the next element.

The various requests may include an address field of the element dispatching the said request, this field preferably being filled in with the address of the initiator element. Thus, an intermediate element sees the request as being dispatched directly by the initiator element and not by the intermediate element, of immediately preceding rank.

In one embodiment, the intermediate element includes means for formulating a third request, the third request comprising the address of the initiator element, the address of an intermediate element, data, and at least one instruction having to be processed by the intermediate element, and means for sending the third request to the said intermediate element.

In one embodiment, the said intermediate element includes means for formulating a fourth request, the fourth request including the address of a slave element, data, and at least one instruction having to be processed by the slave element, and means for sending the fourth request to the said slave element.

The slave element may include means for receiving the fourth request originating from the intermediate element, and means for executing at least one instruction contained in the fourth request. Such a system is particularly well suited for the case where the slave elements are memories, and the intermediate elements are memory controllers.

Advantageously, the modules form part of an integrated circuit. It is particularly advantageous for a single integrated circuit to include the whole system, including the modules.

However, provision may be made for the modules to form part of a plurality of integrated circuits disposed in a common medium, and/or present on removable media connected together. The said removable media may be coupled by a ribbon cable, a coaxial wire, differential pairs, laser diodes, etc. A medium may be formed by a printed circuit card provided with elements soldered or fixed in a removable manner.

In one embodiment, a subsequent request, such as the second request, includes the address of the initiator element in the guise of address of the dispatcher of the second request.

The invention also proposes a method of communicating between modules in an interconnection system including at least three elements, in which: - an initiator element sends a first request to an intermediate element, the said first request including the address of the initiator element, the address of the intermediate element, data, and at least one instruction having to be processed by the intermediate element, - in response to the first request, the intermediate element sends the slave element a second request including the address of the initiator element, the address of the slave element, data, and at least one instruction having to be processed by the slave element, and - in response to the second request, the slave element executes the instruction contained in the second request.

One thus succeeds in optimizing the use of the resources of a communication system while limiting the number of requests or messages dispatched.

In one embodiment, in response to the second request, the slave element sends, furthermore, an acknowledgement of receipt to the initiator element. The slave element may send data to the initiator element or else not dispatch any response. The expression slave element is understood to mean an element situated at the end of a chain of agents involved in a transaction, which is able to execute an instruction, and to advise the initiator element of the transaction. Stated otherwise, the response sent by a slave element to the initiator element is devoid of any instruction. Thus, the transaction may include a plurality of requests each including at least one instruction and, as appropriate, a response including a transaction identifier, the address of the initiator element, an acknowledgement of receipt and/or data.

In one embodiment, in response to the first request, the intermediate element sends another intermediate element a request including the address of the initiator element, the address of the said other intermediate element, data, and at least one instruction having to be processed by the said other intermediate element.

In one embodiment, in response to a request of rank n, an intermediate element of rank n sends an intermediate element of rank n+1 a request of rank n+1 including the address of the initiator element, the address of the intermediate element of rank n+1, data, and at least one instruction having to be processed by the intermediate element of rank n+1.

Advantageously, the initiator, intermediate and slave elements of the interconnection system communicate according to one and the same protocol.

In one embodiment, the first request includes the address of the slave element, and the number of data to be transferred. Stated otherwise, the initiator element formulates a copy request including the address of the initiator element, the address of the intermediate element, an instruction having to be processed by the intermediate element, the address of the slave element and the number of data used, and sends the request to the intermediate element. The intermediate element formulates a storage request including the address of the initiator element, the address of the slave element, an instruction having to be processed by the slave element, data resulting from the execution of the instruction processed by the intermediate element, and sends the storage request to the slave element. The slave element executes the instruction by storing the data.

The instruction to be processed by the slave element is an instruction to load the said data. The data contained in the copy request comprise the address of the intermediate element, and the address of the slave element. An instruction to copy one element to another may therefore be executed with a small number of requests dispatched, hence an increase in the availability of the resources of the communication system.

In one embodiment of the invention, a request includes the address of the initiator element, the address of the request's destination element, an operational instruction, the address of data in a reference of the request's destination element, and a request identifier. The operational instruction may be chosen from among a load, store or copy instruction. A request may include the number of data bytes in the said request. A request may include an element making it possible to match up a request and a response. An initiator element may send a request before having received a response to a request sent earlier. This is particularly advantageous, since the initiator element is not slowed down by waiting for a response to a request for the sending of a later request. One thus succeeds in increasing the speed of data processing by the initiator element.

The method and system therefore allows not only a saving with regard to the communication resources of a communication system, but also a rise in the speed of data processing by the various agents.

### BRIEF DESCRIPTION OF THE DRAWINGS

Other objects and advantages of the invention will become apparent upon reading the following detailed description and upon reference to the accompanying drawings in which:

FIG. 1 is a schematic diagram of a message communication management device of an integrated circuit chip;

FIG. 2 is a schematic diagram of a variant of a communication management device of an integrated circuit chip;

FIG. 3 is a functional diagram of a message asynchronous communication management module; and

FIGS. 4 to 7 are functional diagrams of a communication system according to one aspect of the invention.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

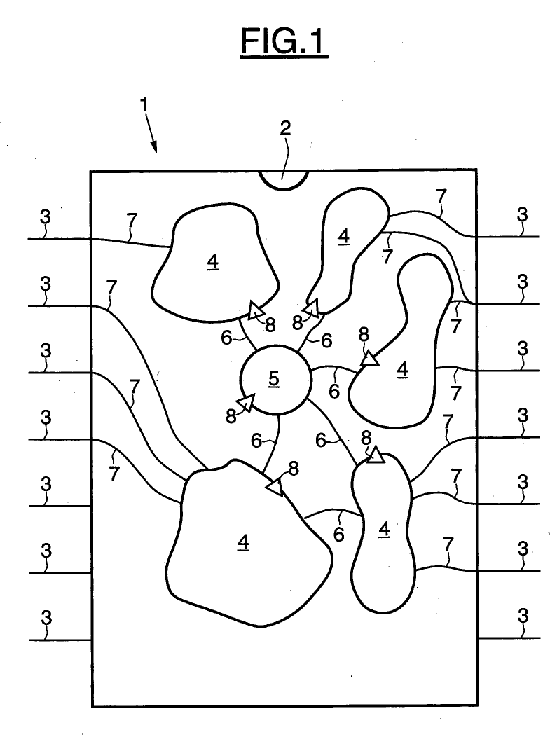

Represented in FIG. 1 is an integrated circuit chip 1 with an orientation indicator 2, and tags 3 for communication with the exterior of the said chip 1. The components of the chip 1, more and more numerous, are grouped together into multisynchronous modules 4. The expression multisynchronous module is understood to mean a circuit subset regulated by one or more clocks dedicated to the said module.

A message asynchronous communication management module 5 coupled to at least two multisynchronous modules 4, here all the multisynchronous modules 4, by point-to-point links 6, manages the communication between the various modules 4 of the integrated circuit chip 1. The modules 4 communicate with the exterior of the chip 1 via links 7 between the modules and tags 3 of the chip 1. Two multisynchronous modules 4 may also, if the design constraints so compel, communicate directly via a point-to-point link 6 identical to the point-to-point links 6 between the asynchronous communication management module 5 and each multisynchronous module 4. It is however preferable for the communications between two synchronous modules 4 to pass via the asynchronous communication management module 5.

An assembly 8 of at least one clock dedicated to a single multisynchronous module determines the references for regulating the operating frequencies of the said multisynchronous module 4. It should be noted that the module 5 is a particular case of multisynchronous module, and that it also possesses its own assembly 8 of at least one clock.

A single specific predetermined communication protocol is used for the communications between the said modules of the chip 1 taking place over the links 6.

Each point-to-point link 6 includes, for each end, means of dispatch and means of receipt of messages, each means of receipt comprising a memory of first in first out type, commonly called a “FIFO stack”.

On a link 6, the clock data and the other data are sent simultaneously. In the course of transport, the clock data undergo a phase shift, and the arriving clock data do not have the same phase as the departing clock data. The other data then undergo a temporal dispersion. If the temporal dispersion is too large, a resynchronization is performed.

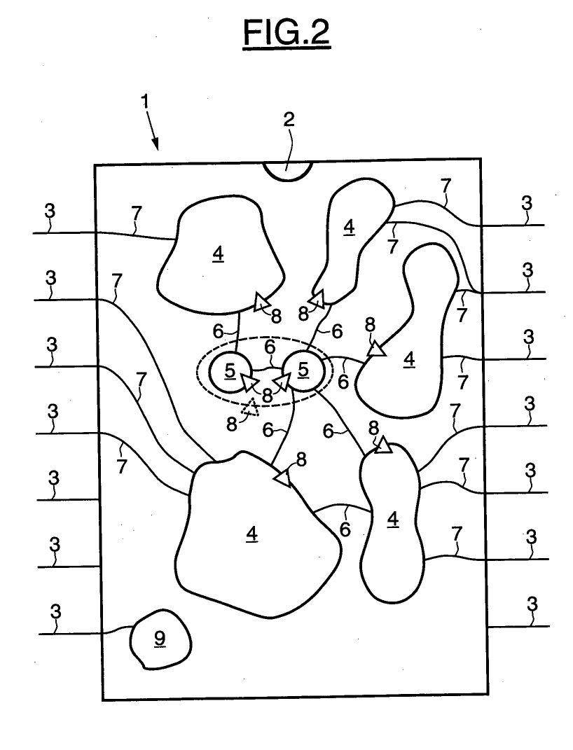

FIG. 2 presents a variant of the device of FIG. 1. The device includes at least two asynchronous communication management modules 5, here two are represented. It may be necessary, having regard to the complexity of a circuit and to its division into a large number of multisynchronous modules, to employ several asynchronous communication management modules 5. Moreover, the circuit may include one or more modules 9, only one of which is represented here, not connected to the asynchronous communication management modules 5. This device may be viewed from the exterior as a single asynchronous communication management module yielding a device similar to that of FIG. 1.

However, there is a difference, since the provision of several asynchronous communication management modules requires additional steps in respect of the communication between two synchronous modules, in particular an additional link 6 for the transferring of the data exchanges, and several successive processing operations corresponding to the number of asynchronous communication management modules.

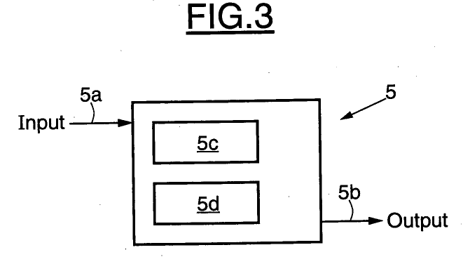

FIG. 3 is a functional diagram of an asynchronous communication management module 5. The latter comprises inputs 5a for receiving data messages originating from other modules and outputs 5b for transmitting data messages to other modules. The messages input are stored temporarily, for example in a memory of the first in first out type, commonly called a “FIFO stack” of the means of receipt of messages of a point-to-point link 6. This temporary storage makes it possible to manage the messages on input, even if they arrive at a higher rate than the capacity of the module 5 to process the messages. The asynchronous communication management module 5 furthermore includes means 5c for routing output messages to their destination module, as well as means 5d for managing the routing of the output messages. A message at input is therefore stored in the FIFO stack of the means of receipt of messages of a point-to-point link 6, then considered by the module 5, which will manage the routing thereof to its synchronous destination module 4 by the means 5c and 5d. This message then exits the module 5 via the output 5b and travels via the means of dispatch of messages of a point-to-point link 6 to the synchronous message destination module 4.

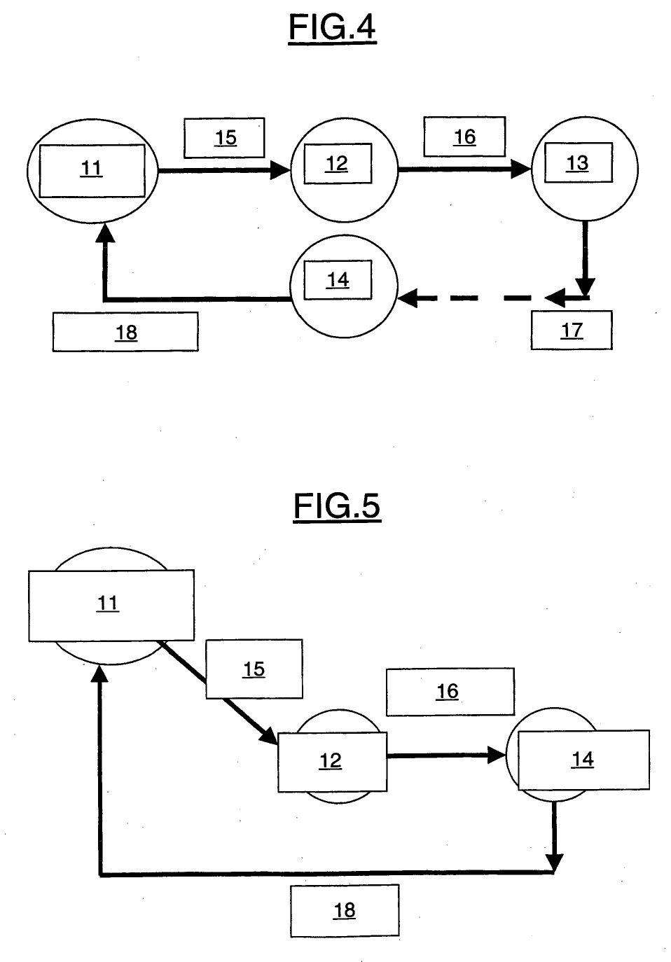

As illustrated in FIG. 4, the communication system includes an element 11, the so-called “initiator element”, able to generate a transaction manifested as a plurality of requests, an intermediate element 12, able to process a request and to send a request, an intermediate element 13, able to receive a request and to dispatch a request, and a slave element 14, able to send data and/or an acknowledgement of receipt to the initiator element 11. The initiator element initiates the transaction by formulating a request including the address of the said initiator element, the address of the intermediate element 12, an operational instruction having to be executed by the intermediate element 12, and, in general, data. The initiator element 11 also includes means for dispatching the said request destined for the intermediate element 12.

The intermediate element 12 receives the request 15 sent by the initiator element 11 and performs a processing on the data received as a function of the operational instruction contained in the request 15 received. The intermediate element 12 includes a means for formulating a second request 16 destined for the intermediate element 13 on the part of the initiator element 11, and a means for sending the said request 16. The request 16 sent by the intermediate element 12 to the intermediate element 13 includes the address of the intermediate element 13, the address of the initiator element 11 in the guise of address of the dispatcher of the said request, an operational instruction having to be executed by the intermediate agent 13, and data.

The intermediate agent 13, which also includes request formulation means and send means, on receipt of the request 16 sent by the intermediate element 12, performs the processing defined by the operational instruction contained in the said request 16 and formulates a request 17 containing, like the previous one, the address of the destination of the said request 17, the address of the initiator element 11 in the guise of address of dispatcher of the said request, data, and an operational instruction. The request 17 generated by the intermediate element 13 may be sent directly to the slave element 14 or to another intermediate element, not represented, it being possible for the transaction to pass through an unlimited number of intermediate elements, between the intermediate element 13 and the slave element 14.

The slave element 14, on receipt of a request 17 originating either from the intermediate element 13 or from the last intermediate element of the chain of intermediate elements, performs the processing defined by the operational instruction contained in the request received and, in response to the said request, can transmit the data and/or an acknowledgement of receipt to the initiator element 11. The slave element 14 may also transmit nothing to the initiator element 11.

It is understood that any request received by an intermediate element or by the slave element includes, in the guise of dispatcher address, the address of the initiator element 11. Thus, each intermediate element and the slave element, receives a request identical to that which it would have received if it had been sent directly from the initiator element 11 to the element considered. One thus succeeds in avoiding modifications of operating protocol.

By way of example, provision may be made for various types of operational instructions that may be contained in the requests: an instruction to store without acknowledgement of receipt, an instruction to store with acknowledgement of receipt, an instruction to supply and store in memory, an instruction to supply, an instruction to copy with no acknowledgement of receipt and an instruction to copy with acknowledgement of receipt.

By way of example, a storage request may comprise a dispatcher addresses field, filled in with the address of the initiator element 11, an addresses field for the request's destination element, a message size field, an operational code defining the operational instruction and a data field. A supply request will have the same structure, with the exception of the data field. A copy request will have the same structure, except that the data field is filled in with the address of the destination slave element.

It is particularly advantageous for each request to furthermore include a relatively short field which makes it possible to match up a request and a response, in so far as the initiator element does not wait for the response to a first request in order to dispatch another request.

FIG. 5 illustrates the case of an application of the invention within the telecommunications sector. Within this sector, certain items of equipment play the role of data disaggregators. A data disaggregator receives as input a high byte rate telecommunications line carrying a very high number of streams, for example a thousand, which are multiplexed. It outputs a thousand independent lines. Such data disaggregation requires the management of a context dependent on each line. Here, the term context is understood to mean the definition of the requirements of each line. Memories of the first in first out type are generally used to store the incoming packets associated with a line. Then, periodically, these first in first out memories are emptied to line interfaces. If the number of memories is high, for example a thousand, the hardware embodiment with one memory per stream is particularly expensive.

The invention proposes a first in first out memories manager making it possible to reduce the number of memories with dynamic allocation of a memory to a line resulting from the execution of management software by a hardware module.

In the example illustrated in FIG. 5, there are provided an intermediate element 12 formed by the memories manager and a slave element 14 formed by a memory. The initiator element 11 sends a request 15 to the intermediate element 12.

In the case of a copy transaction, the request 15 may include the address of the initiator element 11, the address of the intermediate element 12, the number of data bytes, the operational code of the instruction desired, for example storage with acknowledgement of receipt, the address in the intermediate element 12, the address of the slave element 14, the address in the slave element 14, and a transaction identifier. The intermediate element 12, the memories manager, transforms the selected memory address into a physical address present in the memory formed by the slave element 14.

The intermediate element 12 instigates a request 16 including, as dispatcher address, the address of the initiator element 11, as destination address, the memory containing the data of the selected address, the number of data transmitted, the operational code for storage with acknowledgement of receipt, the actual address representing the memory selected, the data and the transaction identifier.

On receipt of the request 16 from the intermediate element 12, the slave element 14, here a memory, containing the data of the selected line, updates the data of the memory selected and then sends an acknowledgement of receipt to the initiator element 11.

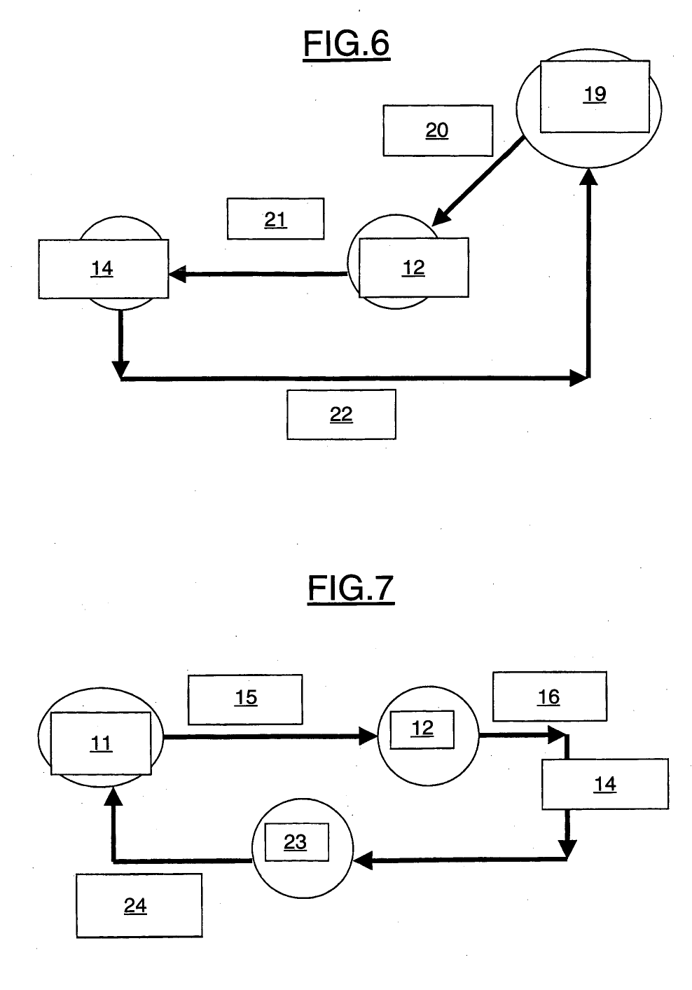

FIG. 6 illustrates the case of an instruction for popping data, present in a memory, from the stack and the sending of the said data to the initiator element 19, which is therefore here another initiator element. The initiator element 19, initiator of the transaction, instigates a request 20 to load data originating from a memory corresponding virtually to the telecommunications line processed. The request of the initiator element 19 is addressed to the memories manager, alias the intermediate element 12, and includes the address of the initiator element 19, the address of the intermediate element 12, the number of data bytes, the operational code and the instruction to store with acknowledgement of receipt, the virtual address of the selected memory and the identifier of the transaction.

The intermediate element 12 performs the transformation of the virtual address of the selected memory to a physical address present in the memory forming the slave element 14 and containing the data of the line processed by the initiator element 19. The intermediate element 12 dispatches a supply request 21 to the slave element 14. The request includes, as dispatcher address, the address of the initiator element 19, the address of the memory containing the data desired for the processed line, the number of bytes, the operational instruction to store with acknowledgement of receipt, the actual address representing the memory selected and the transaction identifier.

On receipt of the said request, the slave element 14, which contains the sought-after data, updates the data of the selected memory and then sends the data to the initiator element 19 in the form of a response 22 containing the address of the initiator element 19, the data and the identifier of the transaction.

FIG. 7 illustrates the case of an intermediate element 12 receiving a request 16 originating from an intermediate element 12 which has itself received a request 15 originating from an initiator element 11. The intermediate element 12 formulates a response and sends it to a slave element 23. The slave element 23 formulates a response 24 and sends it to the initiator element 11. It is therefore possible for a response to be made to travel via a certain number of intermediate elements as a function of the architecture of the system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. System for communicating between modules, comprising an initiator element, at least one intermediate element and one slave element, the initiator element being equipped with means for formulating a first request, and with means for sending the first request to an intermediate element, the said first request comprising the address of the initiator element, the address of the intermediate element, data, and at least one instruction having to be processed by the intermediate element, the intermediate element being equipped with means for receiving a request originating from the initiator element, with means for formulating a second request in response to the first request, and with means for sending the second request to a slave element, the said second request comprising the address of the slave element, at least one instruction having to be processed by the slave element, data, and the address of the initiator element, the slave element being equipped with means for receiving a request originating from the intermediate element, and with means for executing at least one instruction contained in the second request.

2. System according to claim 1, wherein the slave element comprises means for sending an acknowledgement of receipt to the initiator element in response to the second request.

3. System according to claim 1, wherein the slave element comprises means for sending data to the initiator element.

4. System according to claim 1, comprising a plurality of intermediate elements, an nth intermediate element comprising means for sending an (n+1)^{th} request to an (n+1)^{th} intermediate element in response to an nth request, the (n+1)^{th} request comprising the address of the (n+1)^{th} intermediate element, at least one instruction having to be processed by the (n+1)^{th} intermediate element, and the address of the initiator element.

5. System according to claim 1, wherein the first request additionally comprises the address of the slave element, and the number of data to be transferred.

6. System according to claim 1, wherein the intermediate element comprises a memory.

7. System according to claim 1, wherein the said modules form part of an integrated circuit.

8. System according claim 1, wherein the said modules form part of a plurality of integrated circuits disposed in a common medium, and/or present on removable media connected together.

9. System according to claim 1, wherein a subsequent request comprises the address of the initiator element in the guise of address of the dispatcher of the said subsequent request.

10. Method of communicating between modules in an interconnection system comprising at least three elements, in which: - an initiator element sends a first request to an intermediate element, the said first request comprising the address of the initiator element, the address of the intermediate element, data, and at least one instruction having to be processed by the intermediate element, - in response to the first request, the intermediate element sends the slave element a second request comprising the address of the initiator element, the address of the slave element, data, and at least one instruction having to be processed by the slave element, and - in response to the second request, the slave element executes the instruction contained in the second request.

11. Method according to claim 10, in which in response to the second request, the slave element sends, furthermore, an acknowledgement of receipt to the initiator element.

12. Method according to claim 10, in which in response to the second request, the slave element sends, furthermore, data to the initiator element.

13. Method according to claim 10, in which in response to the first request, the intermediate element sends another intermediate element a request comprising the address of the initiator element, the address of the said other intermediate element, data, and at least one instruction having to be processed by the said other intermediate element.

14. Method according to claim 10, in which in response to an n^{th} request, an n^{th} intermediate element sends an (n+1)^{th} intermediate element an (n+1)^{th} request comprising the address of the initiator element, the address of the (n+1)^{th} intermediate element, data, and at least one instruction having to be processed by the (n+1)^{th} intermediate element.

15. Method according to claim 10, in which the initiator, intermediate and slave elements of the interconnection system communicate according to one and the same protocol.

16. Method according to claim 10, in which in response to a copy request, the intermediate element interprets the data contained in the said request as being an address, and formulates a request comprising the initiator element's address contained in the copy request, the address of a slave element, data resulting from the execution of the instruction processed by the intermediate element, and at least one instruction having to be processed by the slave element.

17. Method according to claim 16, in which the instruction having to be processed by the slave element is an instruction to store the said data.

18. Method according to claim 16, in which the data contained in the copy request comprise the address of the slave element.

19. Method according to claim 10, in which a request comprises the address of the initiator element, the address of the request's destination element, an operational instruction, the address of data in a reference of the request's destination element, and a request identifier.

20. Method according to claim 19, in which the operational instruction is chosen from among a load, store or copy instruction.

21. Method according to claim 19, in which a request comprises the number of data bytes in the said request.

22. Method according to claim 19, in which a request comprises an element making it possible to match up a request and a response.

23. Method according to claim 19, in which an initiator element sends a request before having received a response to a request sent earlier.
